(19) United States
(12) Patent Application Publication
(10) Pub. No.: US 2007/0270065 A1
(43) Pub. Date: Nov. 22, 2007

(54) Threads, Fibres and Filaments for Weaving Without Sizing

(76) Inventor: Bertrand Bordes, Lyon (FR)

Correspondence Address: LADAS & PARRY, 26 WEST 61ST STREET, NEW YORK, NY, 10023, US

(21) Appl. No.: 10/580,886

(22) PCT Filed: Nov. 26, 2004
(86) PCT No.: PCT/FR04/03028

§ 371 Date: Mar. 5, 2007

(30) Foreign Application Priority Data
Nov. 26, 2003 (FR) 0313865

(51) Int. Cl. D06M 15/21; B60R 21/16; C08F 290/04

(52) U.S. Cl. 442/155; 524/504; 66/84 R

(57) ABSTRACT

The invention relates to threads, fibres and filaments that can be woven without sizing, and a method for producing said threads, fibres and filaments. The invention especially relates to threads, fibres, and filaments treated by a grafted copolymer. The invention also relates to fabrics obtained without sizing, using said threads, fibres and filaments, and to a method for weaving without sizing, especially by means of a dry loom, using said threads, fibres and filaments. Furthermore, the invention relates to the use of said threads, fibres, filaments and fabrics for producing airbags.

The invention relates to yarns, fibers and filaments which can be woven without sizing and to a process for the manufacture of these yarns, fibers and filaments. The invention relates more particularly to yarns, fibers and filaments treated with a grafted copolymer. It also relates to fabrics obtained from these yarns, fibers and filaments without a sizing stage and to a sizeless weaving process starting from these yarns, fibers and filaments, in particular using a dry loom. Finally, the invention relates to the use of the yarns, fibers and filaments as well as the fabrics in the field of airbags.

When warps are used, mainly in weaving, it is known that the yarns on the one hand rub against one another due to the upward and downward movement of the heddle frames and on the other hand rub against components of the loom, such as eyelets of the heddles through which they pass, dents of the reed, sley, let-off motion, warp stop motions, and the like. In order to prevent the rubbing actions from causing defects harmful to the actual weaving operation and to the quality of the fabric produced, a pretreatment referred to as sizing is carried out on yarns. This treatment, well known through its application to staple fiber yarns in order to provide the fibers with cohesion and to form a sheath which protects the spun yarn, is also applied to continuous artificial and synthetic multifilament yarns; the sizing has to keep in place and protect filaments which generally have low counts, and are therefore easily damaged, and has to surround the continuous yarns with a sheath which prevents the rubbing actions described above and has for this reason to facilitate sliding both over the parts of the loom and between yarns, for the purpose of producing fabrics free from visual defects and while avoiding as much as possible broken ends and drag marks. These sizing products are generally removed after weaving by treatment of the fabric during the desizing operation.

In order to provide the yarn with cohesion, a twisting operation is generally carried out on the latter. However, this twisting operation is increasingly being replaced by an air jet process in which the filaments are intertwined. Thus, depending on the pressure of the fluid and the intertwining means, it is possible to vary the number of cohesion points, that is to say the number of points at which the filaments form a node, according to the final appearance desired for the yarn and its subsequent use.

Sizing products or oils are commonly applied to facilitate sliding of the fibers and yarns. As regards continuous artificial and synthetic yarns, these oils or sizes are applied to the yarn one or more times during the process for its production.

In order to economize on the cost of the sizing and desizing operations and thus to eliminate two operations in which the yarns are handled, attempts have been made to eliminate the sizing operation, which is furthermore harmful to the environment. In addition, the sizing product may prove to be difficult to completely remove, depending on the type of product used, the type of yarn and the construction of the fabric, with the risk of the presence of size residues being carried into the fabric. The presence of these residues may prove to be harmful, in particular in the field of airbags; for example, it may have a detrimental effect on the performance of the product as the latter ages.

Thus, the present invention provides, in a first subject matter, yarns, fibers and filaments which can be woven without sizing, a grafted copolymer being present over at least a portion of the surface of the yarns, fibers and filaments, the grafted copolymer comprising at least three sequences with different chemical natures, including one or more sequence(s) for anchoring to solids, one or more sequence(s) with a hydrophobic nature and one or more sequence(s) with a hydrophilic nature, composed of:
a) 1 to 80% by weight, preferably 5 to 40% by weight, of one or more sequence(s) for anchoring to solids composed of an aromatic, cycloalkyl or linear or branched hydrocarbon chain comprising basic nitrogenous groups of the following type: heterocyclic, —NH₂, —NH—, —NHR or —NR₂, —CONH₂, —CONHR, —CONR₂ (where R is a C₁-C₆ alkyl radical, optionally substituted by one or more —OH, —COO—, —CO—, —O— or —SO₃H groups), which can comprise —COO— groups, the content by weight of basic nitrogenous monomers in the anchoring chain being at least 5% and preferably 30%, and
b) at least 10% by weight, preferably 25 to 80% by weight, of one or more sequence(s) with a hydrophobic nature composed of an aromatic, cycloalkyl or linear or branched hydrocarbon chain which can comprise —COO—, —S—, —F or —Si(OR′)ₙ(R″)₂₋ₙ— groups (where R′ and R″ represent alike or different C₁-C₁₀ alkyl or aryl radicals and n=0 to 2) and formed of monomer units, the solubility parameter of which is less than or equal to 21.5 J^{1/2}/cm^{3/2}, preferably less than 19 J^{1/2}/cm^{3/2},
c) at least 10% by weight, preferably 15 to 70% by weight, of one or more sequence(s) with a hydrophilic nature composed of a linear or branched hydrocarbon chain comprising —O—, —OH , —NCO, —COO—, —COOH , —CONH ₂, —CONHR′″ (where R′″ is a C₁-C₃ alkyl radical), —NH—, —S— or —SO₃H groups and formed of monomer units, the solubility parameter of which is greater than 22 J^{1/2}/cm^{3/2}, preferably greater than 22.5 J^{1/2}/cm^{3/2}.

In a second subject matter, the invention provides a process for the preparation of these yarns, fibers and filaments.

In a third subject matter, the invention provides a fabric obtained in particular from yarns, fibers and filaments as well as a process for producing this fabric.

Finally, in a fourth subject matter, the invention provides for the use of these yarns, fibers, filaments and fabrics in the field of airbags.

Advantageously, there exist three different ways of combining the three types of sequence: anchoring, hydrophobic and hydrophilic. The grafted copolymers according to the invention can thus alternatively exhibit the following structures:
anchoring main chain+at least 2 respectively hydrophilic and hydrophobic grafts,
hydrophobic main chain+at least 2 respectively hydrophilic and anchoring grafts,
hydrophilic main chain+at least two respectively hydrophobic and anchoring grafts.

The solubility parameters, expressed in J^{1/2}/cm^{3/2}, were calculated by the Hoftyzer-Van Krevelen incrementation method or measured experimentally. The molar volumes necessary during the calculation of the solubility parameters are calculated from the Feedor data. These methods of calculation and experimental values are set out in the work: D. W. Van Krevelen, “Properties of Polymers. Their Correlation with Chemical Structure; Their Numerical Estimation and Prediction from Additive Group Contributions”, third edition, Elsevier, 1990, pp. 189-225.

Processes for obtaining the grafted copolymer of the invention are disclosed in patent application WO 97/28200.

Advantageously, the molecular weight of the anchoring sequence(s), of the sequence(s) with a hydrophobic nature and of the sequence(s) with a hydrophilic nature of the grafted copolymer is less than or equal to 10 000.

Advantageously, the anchoring sequence(s) of the grafted copolymer comprises basic nitrogenous groups introduced from one or more compound(s) chosen from:
a) vinylpyridines, such as 2-vinylpyridine, 3-vinylpyridine, 4-vinylpyridine or 2-methyl-5-vinylpyridine,
vinylimidazole, 2-methyl-N-vinylimidazole, vinylcarbazole, N-vinylpyrrolidone, 3-methyl-N-vinylpyrazole, 4-methyl-5-vinylthiazole, N-vinylcaprolactam or ethylimidazolidone meth-acrylate,
(meth)acrylamides, such as (meth)acrylamide, N-methylacrylamide, N-isopropylacrylamide and N,N-dimethylacrylamide,
N-methylol(meth)acrylamide, N,N-dimethylol-(meth)acrylamide, 2-acrylamido-2-methyl-1-pro-panesulfonic acid, diacetone acrylamide, methyl 2-acrylamido-2-methoxyacetate or N,N,N-tris-(hydroxymethyl)methacrylamide,
aminoalkyl (meth)acrylates of following formula

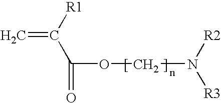

where R₁ is a hydrogen atom or a C₁-C₄ alkyl radical, R₂ and R₃, which are identical or different, each represent a C₁-C₆ alkyl radical and n=0 to 6,

said nitrogenous groups being, in this first case, introduced by radical copolymerization of one or more abovementioned unsaturated ethylenic monomer(s), and
b) N,N-diethyl-1,4-butanediamine, 1-(2-amino-ethyl)piperazine, 2-(1-pyrrolidyl)ethylamine, 4-amino-2-methoxypyrimidine, 2-(dimethylamino)-ethanol, 1-(2-hydroxyethyl)piperazine, 4-(2-hydroxyethyl)morpholine, 2-mercaptopyrimidine, 2-mercaptobenzimidazole, N,N-dimethyl-1,3-propanediamine, 4-(2-aminoethyl)pyridine, N,N-diallylmelamine, 3-amino-1,2,4-triazole, 1-(3-aminopropyl)imidazole, 4-(2-hydroxyethyl)-pyridine, 1-(2-hydroxyethyl)imidazole or 3-mercapto-1,2,4-triazole,

said nitrogenous groups being, in this second case, attached to a linear or grafted copolymer by taking advantage of the reactive functional groups introduced along the preformed chain.

Advantageously, the sequence(s) with a hydrophobic nature of the grafted copolymer are formed from monomer units chosen from:
(meth)acrylic acid esters, such as methyl (meth)acrylate, ethyl (meth)acrylate, propyl (meth)acrylate, butyl (meth)acrylate, hexyl (meth)acrylate, cyclohexyl (meth)acrylate, ethylhexyl (meth)acrylate, octyl (meth)acrylate, nonyl (meth)acrylate, isodecyl (meth)acrylate, lauryl (meth)acrylate, stearyl (meth)acrylate, pentadecyl (meth)acrylate, cetyl (meth)acrylate, behenyl (meth)acrylate or 3-(trimethoxysilyl)-propyl (meth)acrylate,
vinyl esters, such as vinyl acetate, vinyl propionate, vinyl butyrate, vinyl sorbate, vinyl hexanoate, vinyl ethylhexanoate, vinyl laurate or vinyl stearate,
styrene and alkylstyrenes, such as α-methyl-styrene, vinyltoluene or tert-butylstyrene,
dienes, such as butadiene or isoprene, which can be hydrogenated after polymerization,
alkylenes, such as ethylene or propylene,
siloxanes, such as dimethylsiloxane, diphenyl-siloxane or methylphenylsiloxane,
fluorinated compounds, such as trifluoroethyl (meth)acrylate, pentafluoropropyl (meth)acrylate, heptafluorobutyl (meth)acrylate, octafluoropentyl (meth)acrylate, pentadecafluorooctyl (meth)-acrylate, eicosafluoroundecyl (meth)acrylate, vinyl fluoride or tetrafluoroethylene,

or products of polycondensation, polyesters or polyamides.

Advantageously, the sequence(s) with a hydrophilic nature of the grafted copolymer are formed from monomer units chosen from:
ethylene oxide,
acrylic acid, methacrylic acid, maleic acid, fumaric acid or itaconic acid,
acrylamide derivatives, such as (meth)acrylamide, N-methylacrylamide or N-isopropylacrylamide,
ethyleneimine,
vinyl alcohol,
vinylpyrrolidone or vinylmethyloxazolidone,
vinylsulfonate,
sodium methallylsulfonate,
glycerol methacrylate.

Preferably, the grafted copolymer comprises:
a main chain for anchoring to solid particles comprising dialkylaminoethyl (meth)acrylate, N,N-dimethalylacrylamide, 2-vinylpyridine or 4-vinylpyridine groups, alone or as a mixture,
one or more hydrophilic poly(ethylene oxide) grafts, and
one or more hydrophobic grafts based on alkyl (meth)acrylates or vinyl esters, alone or copolymerized with styrene or alkylstyrene derivatives, fluorinated monomers, such as tri-fluoroethyl methacrylate, or 3-(trimethoxysilyl)-propyl methacrylate.

In the case of a multifilament yarn, the treatment makes it possible to improve the cohesion of the filaments with one another.

The yarns, fibers and filaments of the invention can be of natural, artificial and/or synthetic origin. They can also have several origins: mention may be made, by way of example, of a spun yarn of polyamide and cotton fibers.

The yarns, fibers and filaments of the invention are advantageously based on thermoplastic polymer. Mention may be made, by way of example, as thermoplastic (co)polymer suitable in the context of the invention, of polyolefins, polyesters, poly(alkylene oxide)s, polyoxyalkylenes, polyhaloalkylenes, poly(alkylene phthalate or terephthalate)s, poly(pheny or phenylene)s, poly(phenylene oxide or sulfide)s, poly(vinyl acetate)s, poly(vinyl alcohol)s, poly(vinyl halide)s, poly(vinylidene halide)s, polyvinylnitriles, polyamides, polyimides, polycarbonates, polysiloxanes, polymers of acrylic or methacrylic acid, polyacrylates or -methacrylates, natural polymers which are cellulose and its derivatives, synthetic polymers, such as synthetic elastomers, or thermoplastic copolymers comprising at least one monomer identical to any one of the monomers included in the abovementioned polymers, as well as the blends and/or alloys of all these (co)polymers.

Mention may be made, as other preferred thermoplastic polymers of the invention, of semicrystalline or amorphous polyamides, such as aliphatic polyamides, semiaromatic polyamides and more generally the linear polyamides obtained by polycondensation between an aromatic or aliphatic saturated diacid and an aliphatic or aromatic saturated di(primary amine), the polyamides obtained by condensation of a lactam or of an amino acid or the linear polyamides obtained by condensation of a mixture of these various monomers.

More specifically, these copolyamides can, for example, be poly(hexamethylene adipamide), the polyphthalamides obtained from terephthalic and/or isophthalic acid, such as the polyamide sold under the trade name Amodel, or the copolyamides obtained from adipic acid, hexa-methylenediamine and caprolactam.

Advantageously, the thermoplastic polymer is a polyester, such as poly(ethylene terephthalate) (PET), poly(propylene terephthalate) (PPT), poly(butylene terephthalate) (PBT), their copolymers and blends.

More preferably still, the thermoplastic polymer is selected from the group of (co)polyamides consisting of polyamide 6, polyamide 6,6, polyamide 4, polyamide 11, polyamide 12, the polyamides 4-6, 6-10, 6-12, 6-36 and 12-12, their copolymers and blends.

The yarns, fibers and filaments of the invention can be based on a blend of thermoplastic polymers or of thermoplastic copolymers.

The yarns, fibers and filaments of the invention can comprise additives, such as reinforcing fillers, flame retardants, UV stabilizers, heat stabilizers, mattifying agents, such as titanium dioxide, bioactive agents, and the like.

The copolymer advantageously represents between 0.1 and 5% by weight, with respect to the weight of the yarn, preferably between 0.2 and 2%.

The overall count of the yarns of the invention can be chosen throughout the range of the usual counts for yarns, for example between 10 dtex and 1100 dtex. In the field of airbags, the overall count is advantageously between 200 and 950 dtex.

The strand count of the yarns of the invention can be chosen throughout the range of the usual counts for yarns. The strand count is generally greater than or equal to 0.3 dtex. It is usually less than the equivalent in dtex of a diameter of 800 microns in the case of monofilaments with a large diameter. In the field of airbags, the yarns are generally multifilament yarns and the strand count is advantageously between 1.5 and 7 dtex.

The invention also relates to a process for the preparation of the yarns, fibers and filaments comprising the following stages:
1) spinning the constituent material of the yarn,
2) optionally drawing the yarn,
3) optionally texturing the yarn,
4) treating the yarn using a liquid comprising the grafted copolymer as described above.

The spinning stage 1) is carried out according to any method known to a person skilled in the art.

When the material of the yarn is a thermoplastic polymer, stage 1) is advantageously a stage of melt spinning the polymer.

The yarns, fibers and filaments of the invention can be subjected to drawing. Thus, the yarn can be drawn along the spinning path according to any known process, to the degree desired according to the orientation and the mechanical characteristics which it is desired to confer on it. It can also be simply preoriented or spin-oriented according to the final winding rate. It can be obtained directly or taken up on rolls to adjust the winding tension, if this proves useful or necessary. Stage 2) may or may not be carried out integrally with the spinning.

The winding rate is generally between 400 and 8000 m/min, advantageously between 600 and 5000 m/min, preferably between 700 and 3500 m/min.

The texturing stage 3) can be carried out according to any method known to a person skilled in the art.

The treatment stage 4) can be carried out before or after the optional drawing stage. The treatment stage 4) can also be carried out before or after the optional texturing stage 3). The copolymer of the treatment of stage 4) is generally employed in the form of a solution, of an emulsion or of a dispersion in a liquid.

The copolymer can, for example, be employed in the form of an aqueous solution.

The copolymer can also be incorporated in conventional lubricating compositions.

The lubricating agents suitable for the invention are all the lubricating agents conventionally used in the field of the spinning of polymers, in particular of the spinning of polyamides or of polyesters. The lubricating compositions are usually oils or aqueous emulsions.

The liquid of the process of the invention can also comprise other compounds than the grafted copolymer and optionally a lubricating agent, such as surface-active agents or antistatic agents, which are conventionally employed in lubricating compositions.

According to a specific embodiment of the invention, the copolymer represents between 5 and 35% by weight, with respect to the weight of the liquid, preferably between 10 and 20%.

The treatment of stage 4) can be carried out according to standard techniques, such as roll coating or coating with spin-finish device (“gudulettes” in French language). Mention can be made, among the standard techniques, by way of example without implied limitation, of the technique for the treatment of the raw fiber with a roll, by spraying or vaporizing, by dipping, the padding technique, and any method used in the textile industry for the treatment of synthetic fibers. This treatment can be carried out at different stages in the manufacture of the yarns. They are, inter alia, all the stages where lubricating agents are conventionally added. It is thus possible to apply the additive at the bottom of the spinning frame before winding. It is also possible, in the case of “fiber” processes, to apply the additive before, during or after the drawing, crimping or drying stages, and the like.

In some cases, it can in addition be advantageous to subject the yarn to a first preliminary treatment (pretreatment) according to methods known to a person skilled in the art, in order to promote the adhesion of the grafted copolymer to the yarn. In addition, it will also be possible to envisage subjecting the yarn, before or after the treatment of stage 4), to other chemical or physical treatments, such as, for example, irradiation, dyeing and others.

The invention also relates to a fabric comprising at least in part yarns, fibers and filaments as described above and to a process for producing this fabric. The yarns used to produce the fabric can be identical or different in nature; for example, it is possible to employ polyamide warp yarns and cotton weft yarns.

The yarns of the invention can be used, for example, as warp yarns on industrial looms. They make it possible in particular to produce a fabric without a sizing stage.

The yarns of the invention, when they are used as warp yarns, can be easily employed either in direct warping or in sectional warping without requiring sizing and can be woven on any type of loom, in particular on high speed looms used industrially.

In some cases, for example when the yarn is intended to be woven on looms on which the warp yarns are subjected to high stresses, it may be preferable to carry out waxing of the yarns with any product generally used before carrying out the weaving.

Advantageously, the fabrics comprising the yarns of the invention are obtained using a dry loom, such as an air jet loom, a rapier loom or a gripper-projectile loom.

The yarns, fibers, filaments and fabrics of the invention are of particular use in the field of airbags. The yarns can be used for the production of fabrics for airbags. These fabrics are produced without a sizing stage, which simplifies, at least with regard to the weaving, the method for obtaining such articles and reduces its cost.

The presence of the grafted copolymer at the surface of the yarns, fibers and filaments does not affect the subsequent treatments to which the fabric may be subjected, in particular when the fabric is used in the field of airbags. Mention may be made, by way of example of such subsequent treatments, of heat-setting, coating with an elastomer, and the like.

Other details or advantages of the invention will become more clearly apparent in the light of the examples given below purely by way of indication.

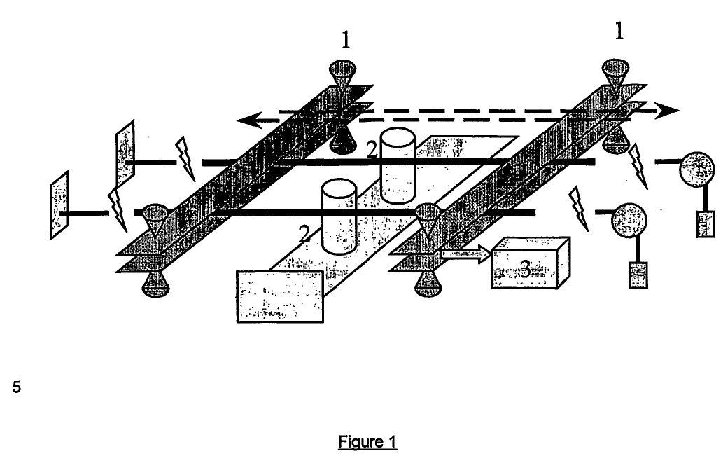

The method of abrading the yarn for the purpose of determining its cohesive index after abrasion is represented in a simplified manner in FIG. 1.

Test For Determining Cohesive Index of the Yarn, Before and After Abrasion

A bobbin of yarn to be tested is conditioned at 23° and at a relative humidity of 63% for at least 48 h.

The cohesive index conferred on the individual filaments of the yarn is evaluated according to the following method: the yarn is cut with a blade on a “Shirley” device. The vibrations emitted by the blade as it cuts the individual filaments are recorded and counted. The cohesive index is defined by the relationship:

$$Cohesive index ( \% ) = 100 \times \frac{number of filaments - number of vibrations}{number of filaments - 1}$$

For this reason, the cohesive index is 0% if all the filaments are cut individually and 1 if all the filaments are cut as a single object.

The cohesive index is determined before and after abrading the yarn on a wearmeter. The method for abrading using a wearmeter is represented diagrammatically in FIG. 1: 15 yarns are placed in parallel and prestretched using weights. These yarns are subsequently gripped between two jaws (1), on either side of the abrasion region, and then cut beyond the jaws. The abrasion blocks (2) are then pushed against the yarns as far as a stop. The tension between the 2 jaws is controled by a force cell (3) and adjusted to 3 cN/tex. The test is subsequently started: the jaws assembly oscillates so as to rub the yarns against the abrasion blocks, for 50 cycles. This device reproduces in a simplified way the main stresses to which the warp yarns are subjected on a loom: tension and yarn/metal rubbing.

### EXAMPLES

### Example 1

A polyamide 6,6 yarn A sold by Rhodia Industrial Yarns AG under the reference T644 (470f68: 470 filaments with a strand count of 68 dtex) is unwound and passed between two rolls in a bath comprising a treatment as described in table 1 below, before being wound at 450 m/min.

The ease of unwinding of the bobbin is evaluated qualitatively and the cohesive index of the yarn before and after is determined according to the method described above.

TABLE 1

| | | | | Cohesive |
|---|---|---|---|---|
| | | Ease of | | index |
| | | unwinding | | after 50 |
| | | of the | Cohesive | abrasion |
| Example | Treatment | bobbin | index | cycles |
| Comparative A | None | Easy | 5% | 2% |
| 1 | Bath comprising | Easy | 22% | 12% |
| | 10% by weight | | | |
| | of Copojef, | | | |
| | grafted | | | |
| | copolymer sold | | | |
| | by Rhodia PPMC, | | | |
| | in water | | | |

The yarn treated with the grafted copolymer can be easily handled and exhibits very good cohesive properties, both before and after abrasion, in comparison with an untreated yarn.

### Example 2

The untreated yarn A according to the above comparative example is warped using a sectional warper, so as to prepare a warp A with a length of 70 m, a width of 1.60 m and a density of 15 yarns/cm.

Likewise, the yarn according to example 1, treated with the grafted copolymer, is warped in the same way, so as to form a warp 2.

The two warps are woven on an air jet loom at 500 strokes/min, with the yarn A as weft.

The fabric produced from the warp A exhibits numerous fragmented warp and weft yarns, numerous broken warp strands, which makes it necessary to reduce the tension of the warp, and opening of the warp yarns on the nozzles for throwing back the filling, resulting in numerous visual defects. Furthermore, after obtaining 20 m of fabric, the warp yarns placed at the end of the reed (2 yarns per dent at this point) cross, completely blocking the operation of the loom.

On the other hand, the fabric produced from the warp 2 exerts a significant decrease in the fraying, in particular on the edges; the crossings of yarns on the warp no longer result in visual defects and the presence of a few broken strands does not, however, bring about visual defects on the fabric. The operation is much better and 70 m of fabric are obtained with few stoppages.

The weaving using the warp 2 could be carried out without problems and without the need for a sizing stage, which represents a significant advantage.

1-24. (canceled)

25. A yarn, fiber or filament which can be woven without sizing, wherein a grafted copolymer is present over at least a portion of the surface of the yarns, fibers and filaments, the grafted copolymer comprising at least three sequences with different chemical natures, including one or more sequence(s) for anchoring to solids, one or more sequence(s) with a hydrophobic nature and one or more sequence(s) with a hydrophilic nature, composed of:
a) 1 to 80% by weight, optionally 5 to 40% by weight, of one or more sequence(s) for anchoring to solids composed of an aromatic, cycloalkyl or linear or branched hydrocarbon chain having basic nitrogenous groups of the following type: heterocyclic, —NH₂, —NH—, —NHR or —NR₂, —CONH ₂, —CONHR, —CONR₂ (where R is a C₁-C₆ alkyl radical, optionally substituted by one or more —OH, —COO—, —CO—, —O— or —SO₃H groups), which can comprise —COO— groups, the content by weight of basic nitrogenous monomers in the anchoring chain being at least 5% and preferably 30%, and
b) at least 10% by weight, optionally 25 to 80% by weight, of one or more sequence(s) with a hydrophobic nature composed of an aromatic, cycloalkyl or linear or branched hydrocarbon chain which has —COO—, —S—, —F or —Si(OR′)ₙ(R″)₂₋ₙ— groups, wherein R′ and R″ represent alike or different C₁-C₁₀ alkyl or aryl radicals and n=0 to 2, and formed of monomer units, the solubility parameter of which is less than or equal to 21.5 J^{1/2}/cm^{3/2}, optionally less than 19 J^{1/2}/cm^{3/2},
c) at least 10% by weight, optionally 15 to 70% by weight, of one or more sequence(s) with a hydrophilic nature composed of a linear or branched hydrocarbon chain having —O—, —OH , —NCO, —COO—, —COOH, —CONH₂, —CONH R′″ (where R′″ is a C₁-C₃ alkyl radical), —NH—, —S— or —SO₃H groups and formed of monomer units, the solubility parameter of which is greater than 22 J^{1/2}/cm^{3/2}, optionally greater than 22.5 J^{1/2}/cm^{3/2}.

26. The yarn, fiber or filament as claimed in claim 25, wherein the molecular weight of the anchoring sequence(s), of the sequence(s) with a hydrophobic nature and of the sequence(s) with a hydrophilic nature of the grafted copolymer is less than or equal to 10 000.

27. The yarn, fiber or filament as claimed in claim 25, wherein the anchoring sequence(s) of the grafted copolymer has basic nitrogenous groups coming from one or more compound(s) chosen from:
a) vinylpyridines, such as 2-vinylpyridine, 3-vinylpyridine, 4-vinylpyridine or 2-methyl-5-vinylpyridine,
vinylimidazole, 2-methyl-N-vinylimidazole, vinylcarbazole, N-vinylpyrrolidone, 3-methyl-N-vinylpyrazole, 4-methyl-5-vinylthiazole, N-vinylcaprolactam or ethylimidazolidone methacrylate,
(meth)acrylamides, such as (meth)acrylamide, N-methylacrylaamide, N-isopropylacrylamide and N,N-di-methylacrylamide,
N-methylol(meth)acrylamide, N,N-dimethylol-(meth)acrylamide, 2-acrylamido-2-methyl-1-propanesulfonic acid, diacetone acrylamide, methyl 2-acrylamido-2-methoxyacetate or N,N,N-tris(hydroxymethyl)methacrylamide,
aminoalkyl (meth)acrylates of following formula 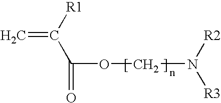
wherein R₁ is a hydrogen atom or a C₁-C₄ alkyl radical, R₂ and R₃, which are identical or different, each represent a C₁-C₆ alkyl radical and n=0 to 6, said nitrogenous groups being, in this first case, introduced by radical copolymerization of one or more abovementioned unsaturated ethylenic monomer(s), and
b) N,N-diethyl-1,4-butanediamine, 1-(2-amino-ethyl)piperazine, 2-(1-pyrrolidyl)ethylamine, 4-amino-2-methoxypyrimidine, 2-(dimethylamino)ethanol, 1-(2-hydroxyethyl)piperazine, 4-(2-hydroxyethyl)morpholine, 2-mercapto-pyrimidine, 2-mercaptobenzimidazole, N,N-dimethyl-1,3-propanediamine, 4-(2-aminoethyl)pyridine, N,N-diallylmelamine, 3-amino-1,2,4-triazole, 1-(3-aminopropyl)imidazole, 4-(2-hydroxyethyl)pyridine, 1-(2-hydroxyethyl)imidazole or 3-mercapto-1,2,4-triazole,
said nitrogenous groups being, in this second case, attached to a linear or grafted copolymer by taking advantage of the reactive functional groups introduced along the preformed chain.

28. The yarn, fiber or filament as claimed in claim 25, wherein the sequence(s) with a hydrophobic nature of the grafted copolymer are formed from monomer units slected from the group consisting of:
(meth)acrylic acid esters, such as methyl (meth)acrylate, ethyl (meth)acrylate, propyl (meth)acrylate, butyl (meth)acrylate, hexyl (meth)acrylate, cyclohexyl (meth)acrylate, ethylhexyl (meth)acrylate, octyl (meth)acrylate, nonyl (meth)acrylate, isodecyl (meth)acrylate, lauryl (meth)acrylate, stearyl (meth)acrylate, pentadecyl (meth)acrylate, cetyl (meth)acrylate, behenyl (meth)acrylate or 3-(trimethoxysilyl)propyl (meth)acrylate,
vinyl esters, vinyl sorbate, vinyl hexanoate, vinyl ethylhexanoate, vinyl laurate or vinyl stearate,
styrene and alkylstyrenes,
dienes, optionally hydrogenated after polymerization,
alkylenes,
siloxanes,
fluorinated compounds, and
products of polycondensation, polyesters or polyamides.

29. The yarn, fiber or filament as claimed in claim 25, wherein the sequence(s) with a hydrophilic nature of the grafted copolymer are formed from monomer units selected from the group consisting of:
ethylene oxide,
acrylic acid, methacrylic acid, maleic acid, fumaric acid or itaconic acid,
acrylamide derivatives, such as (meth)acrylamide, N-methylacrylamide or N-isopropylacrylamide,
ethyleneimine,
vinyl alcohol,
vinylpyrrolidone or vinylmethyloxazolidone,
vinylsulfonate,
sodium methallylsulfonate, and
glycerol methacrylate.

30. The yarn, fiber or filament as claimed in claim 25, wherein the grafted copolymer comprises:
a main chain for anchoring to solid particles comprising dialkylaminoethyl (meth)acrylate, N,N-dimethalylacrylamide, 2-vinylpyridine or 4-vinylpyridine groups, alone or as a mixture,
one or more hydrophilic poly(ethylene oxide) grafts, and
one or more hydrophobic grafts based on alkyl (meth)acrylates or vinyl esters, alone or copolymerized with styrene or alkylstyrene derivatives, fluorinated monomers, such as trifluoroethyl methacrylate, or 3-(trimethoxysilyl)propyl methacrylate.

31. The yarn, fiber or filament as claimed in claim 25, based on thermoplastic polymer.

32. The yarn, fiber or filament as claimed in claim 31, wherein it is based on polyester or on polyamide.

33. The yarn, fiber or filament as claimed in claim 25, wherein the grafted copolymer represents between 0.1 and 5% by weight, optionally between 0.2 and 2% by weight, with respect to the weight of the yarn.

34. The yarn, fiber or filament as claimed in claim 25, wherein the overall count of the yarn is between 200 and 950 dtex.

35. The yarn, fiber or filament as claimed in claim 25, wherein the strand count of the yarn is between 1.5 and 7 dtex.

36. A process for the preparation of the yarn, fiber or filament as claimed in claim 25, comprising the following stages:
1) spinning the constituent material of the yarn,
2) optionally drawing the yarn,
3) optionally texturing the yarn, and
4) treating the yarn using a liquid comprising the grafted copolymer defined as claimed in claim 25.

37. The process as claimed in claim 35, wherein the material is a thermoplastic polymer and in stage 1), is a melt spinning of the polymer.

38. The process as claimed in claim 35, wherein stage 4) is carried out after stages 2) and 3).

39. The process as claimed in claim 35, wherein stage 4) is carried out before stages 2) and 3).

40. The process as claimed in claim 35, wherein the liquid is a lubricating composition.

41. The process as claimed in claim 35, wherein the grafted copolymer represents between 5 and 35% by weight, with respect to the weight of the liquid, preferably between 10 and 20%.

42. A fabric, comprising at least in part the yarn, fiber or filament as claimed in claim 25.

43. A process for the preparation of a warp and weft fabric as claimed in claim 19, comprising the weaving carried out on a loom, at least a portion of the warp yarns being the yarn as claimed in one of claims 1 to 12 or the yarn, fiber or filament obtained by the process as claimed in one of claims 13 to 18.

44. An airbag comprising a fabric produced from yarns, fibers or filaments as claimed in claim 25.
